(19) United States
(12) Patent Application Publication
(10) Pub. No.: US 2002/0004746 A1
(43) Pub. Date: Jan. 10, 2002

(54) E-coupon channel and method for delivery of e-coupons to wireless devices

(76) Inventors: John B. Ferber, Baltimore, MD (US); Aleck H. Schleider, Baltimore, MD (US); John F. Demayo, Baltimore, MD (US)

Correspondence Address: Finnegan, Henderson, Farabow,, Garrett & Dunner, L.L.P., 1300 I Street, N.W., Washington, DC, 20005-3315, US

(21) Appl. No.: 09/835,396

(22) Filed: Apr. 17, 2001

Related U.S. Application Data
(60) Provisional application No. 60/198,092, filed on Apr. 17, 2000.

(51) Int. Cl. G06F 17/60

(52) U.S. Cl. 705/14

(57) ABSTRACT

Methods and apparatus for providing electronic coupons from a processor to a user device are provided. In operation, the user device determines information identifying a user and requests, from a processor, an electronic coupon based on user's identity. The processor then determines a profile of the user and selects at least one electronic coupon. The processor provides the coupon to the user device, such that the coupon may be redeemed directly from the user device. The system for providing electronic coupons may include databases for profiles of a plurality of users and a plurality of electronic coupons. Accordingly, the processor may select one or more electronic coupons which are targeted to the user.

### CROSS REFERENCE TO RELATED APPLICATIONS

This application claims the benefit of U.S. Provisional Patent Application No. 60,198,092, entitled “e-COUPON CHANNEL AND METHOD FOR DELIVERY OF e-COUPONS TO WIRELESS DEVICES,” filed on Apr. 17, 2000, the disclosure of which is expressly incorporated herein by reference in its entirety.

### FIELD OF THE INVENTION

This invention relates generally to electronic commerce and providing incentives. More particularly, the invention is directed to a system and method for providing an electronic coupon (e-coupon) channel for wireless devices and using e-coupons.

### BACKGROUND OF THE INVENTION

Discount coupons (for example, “cents-off” coupons, rebate coupons, special offer coupons, or the like, collectively referred to herein as “coupons”) have become an integral part and a popular means of marketing strategies for many products, particularly retail consumer goods, sundries, foodstuffs, hardware, clothing and the like. Such items are typically sold at local grocery, drug, and discount stores. Product manufacturers have come to rely upon coupons, rebate and gift certificates to promote new and existing products, boost sales, and obtain demographic information concerning consumer-buying patterns.

In recent times, consumers have increasingly relied on coupons to reduce out-of-pocket costs. For example, in 1992, approximately 10 billion coupons were distributed, with 7.7 billion coupons being redeemed, saving consumers approximately 4 billion dollars. It has been estimated that coupons, coupled with advertising, can increase sales by as much as 500%. A typical coupon-marketing scheme involves printing the coupons in the newspaper or inserting coupon inserts into the newspaper, and allowing consumers to bring the printed coupons to a store for redemption. Other means of distributing coupons include printing or inserting in magazines or other publications, by direct mail methods, by printing Web-based coupons, and by placement on or with products distributed at retail establishments.

Known coupon delivery and redemption techniques have several drawbacks, not the least of which are low response rate, fraud, and high administrative processing costs. Low response rates are due in part to the difficulty a consumer has in maintaining, cataloging, and finding appropriate coupons before or during shopping. Moreover, since many coupons have expiration dates, a consumer has to not only catalogue each coupon by its product type, but also catalogue the coupons to ensure that redemption occurs before an expiration date. The time-consuming and cumbersome process associated with redeeming coupons has acted to reduce or even eliminate their appeal to consumers on a budget or consumers who redeem coupons as a hobby. Accordingly, there is a need in the industry to simplify the process of coupon redemption by increasing the response rates, while at the same time reducing consumer coupon collection and management time.

In the present on-line environment, most conventional Internet Web pages viewed on personal computers use an advertising-based model, where advertisers pay web-site operators a fee to display ads and/or pay fees based on the number of times the ads are “clicked.” However, this model is not as suited to the small screens found on wireless Internet devices such as Web-enabled mobile phones, palm-sized computers, and personal digital assistants (PDAs), where ads would be difficult to display and use.

### SUMMARY OF THE INVENTION

In accordance with the invention, the present invention solves these problems with an e-coupon channel for wireless devices coupled with a method of delivering and using e-coupons.

The present invention may eliminate the difficulties associated with paper coupons through the delivery of e-coupons to a portable user device, such as a wireless device for storage, sorting, and redemption. The present invention provides an e-coupon channel for user devices through which e-coupons can be delivered and stored. The present invention also allows wireless Internet providers to derive revenue from advertisers through delivery of advertiser's e-coupons to the provider's wireless Internet users.

A user's interests and/or e-coupon redemption may be tracked in order to target e-coupon delivery. An e-coupon server may be connected to the Internet for delivering e-coupons to wireless web-enabled devices through wireless providers connected to the Internet. The e-coupon may be presented for redemption using a display on the user device. In addition, the redemption and logged usage of e-coupons may be displayed.

In accordance with one aspect of the present invention, e-coupons are provided from a processor to a user device. The user device determines a user identity and requests, from a processor, an e-coupon based on the user's identity. The processor then determines a profile of the user. The processor selects at least one e-coupon based on the profile of the user and provides it to the user device.

In accordance with another aspect of the present invention, a system for providing electronic coupons comprises: a user device for determining information identifying a user; a first memory for storing profile information for the user; a second memory for storing a plurality of electronic coupons; and a processor for retrieving the profile of the user and selecting at least one of the plurality of electronic coupons based upon the user's profile.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 illustrates a system for distributing e-coupons consistent with the present invention;

FIG. 2 illustrates an e-coupon channel displayed on a wireless device consistent with the present invention;

FIG. 3 illustrates a plurality of e-coupons displayed on a wireless device consistent with the present invention;

FIG. 4 illustrates an e-coupon presented for redemption consistent with the present invention; and

FIG. 5 illustrates a method for presenting e-coupons consistent with the present invention.

### DETAILED DESCRIPTION

Reference will now be made in detail to the present embodiments of the invention, examples of which are illustrated in the accompanying drawings. Wherever possible, the same reference numbers will be used throughout the drawings to refer to the same or like parts.

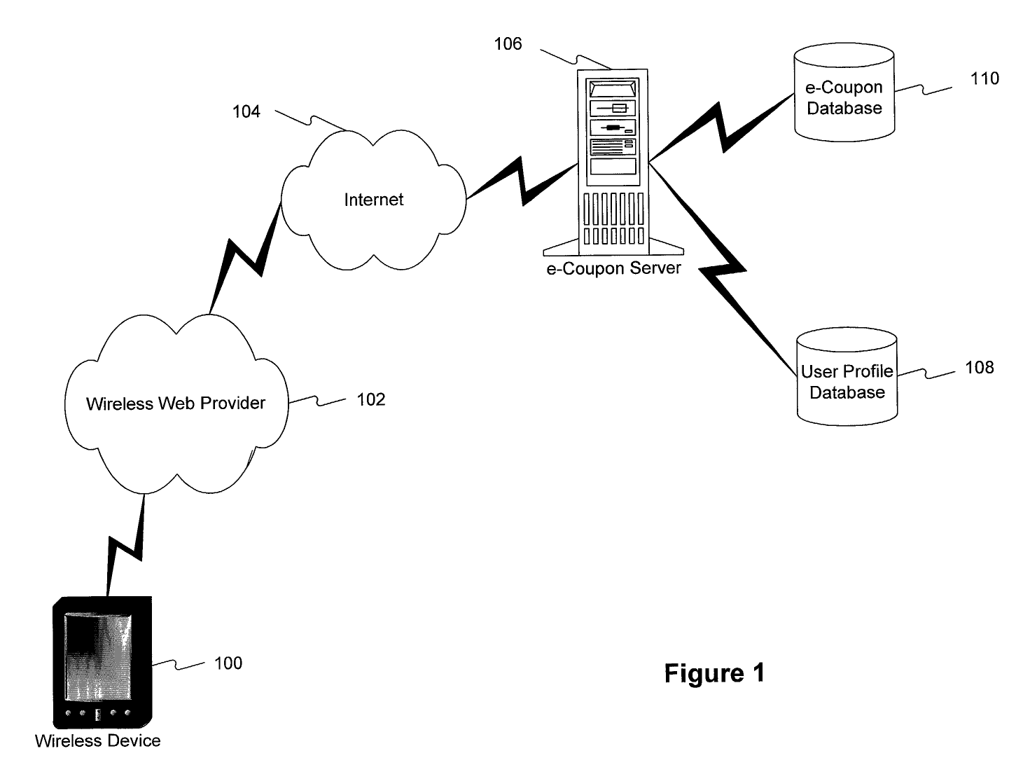

FIG. 1 illustrates a system for distributing e-coupons to a wireless device consistent with the present invention. In particular, a wireless device 100, a wireless web provider 102, a public network 104, an electronic coupon (e-coupon) server 106, an e-coupon database 110, and a user profile database 108 are shown. Wireless device 100 may be any wireless web-enabled device such as mobile phones, palm-size computers, PDAs, automobile-based PCs, etc. Wireless web provider 102 may be a wireless content provider service, such as AvantGo (TM), OmniSky (TM), Palm.net (TM), and Sprint PCS (TM).

In one embodiment, the public network 104 is the Internet and the e-coupon server 106 is connected to the public network 104 via a data link. Alternatively, the e-coupon server 106 may be implemented as dedicated hardware or software integrated within another device, e.g., within a web server for an e-coupon channel. User profile database 108 is a mass storage device capable of storing information about a plurality of users in order to build consumer profiles for each user. The consumer profiles may be updated by the user directly and by the e-coupon server 106 in response to user behavior, such as browsing other selected channels or e-coupon use. Accordingly, the profile may be used to select e-coupons targeted at the interests and/or consumption patterns of the user. The e-coupon database 110 stores the variety of e-coupons that may be targeted to the user.

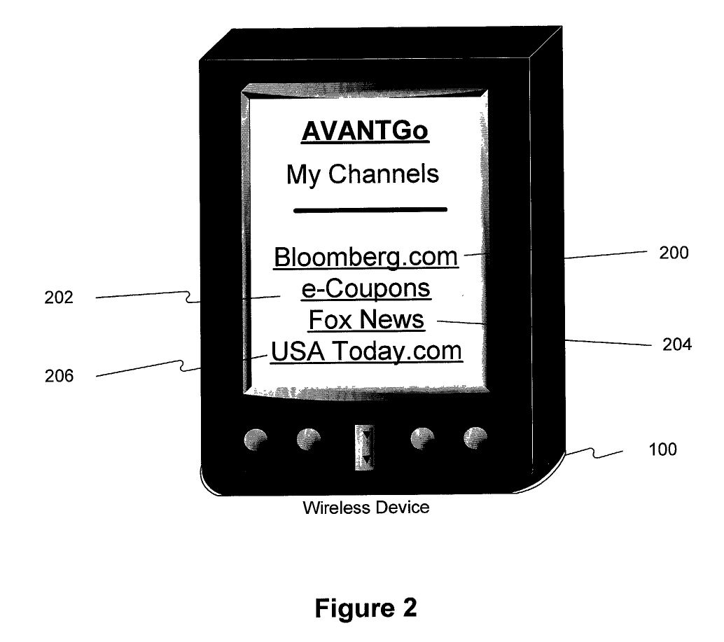

As shown in FIG. 2, the wireless device 100 may display one or more channels 200, 202, 204, and 206 in a menu format. When the “e-Coupons” channel 202 is selected by the user, the wireless device 100 may download new e-coupons from e-coupon database 110 and store the new e-coupons in a memory location of the wireless device 100. Wireless device 100 may also delete any expired e-coupons from a memory location in the wireless device 100.

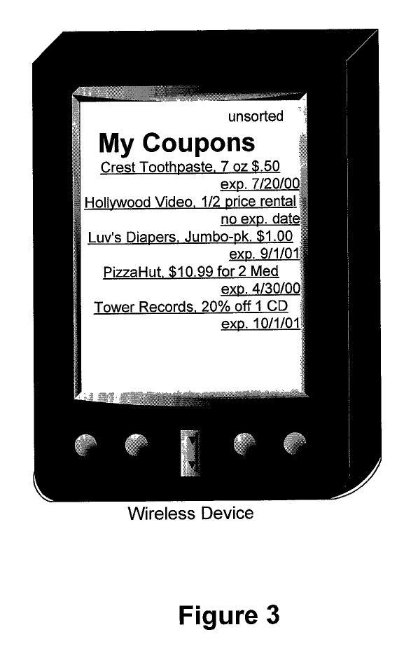

As shown in FIG. 3, the e-coupons may be sorted and searched using one or more menus (not shown) displayed on the wireless device 100. For example, the user may edit and name sorting categories, sort and search by expiration date, sort and search by alphabetical order, sort and search by amount, etc.

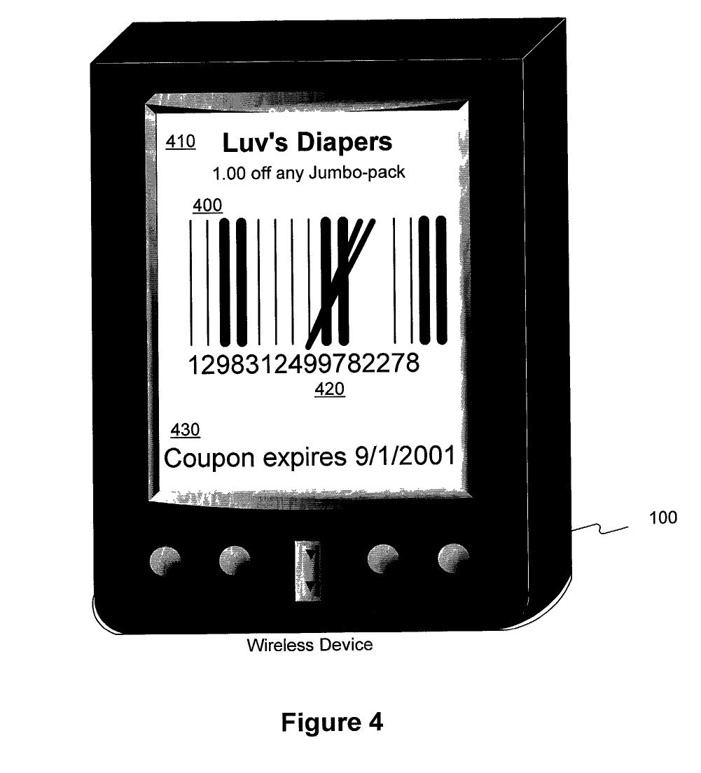

Referring to FIG. 4, it is shown that the wireless device 100 may allow the e-coupon to be redeemed. As shown in FIG. 4, a machine readable bar code 400 may be displayed on the display 410 of the wireless device 100. In addition, a human readable portion 420 and an expiration date portion 430 for the e-coupon may appear on the display 410. The machine readable bar code 400 may be scanned by coupon scanning devices (not shown) directly from the display of the wireless device 100. Alternatively, a human operator may manually input the human readable portion 420 into an input device (not shown), such as a cash register in order to redeem the e-coupon.

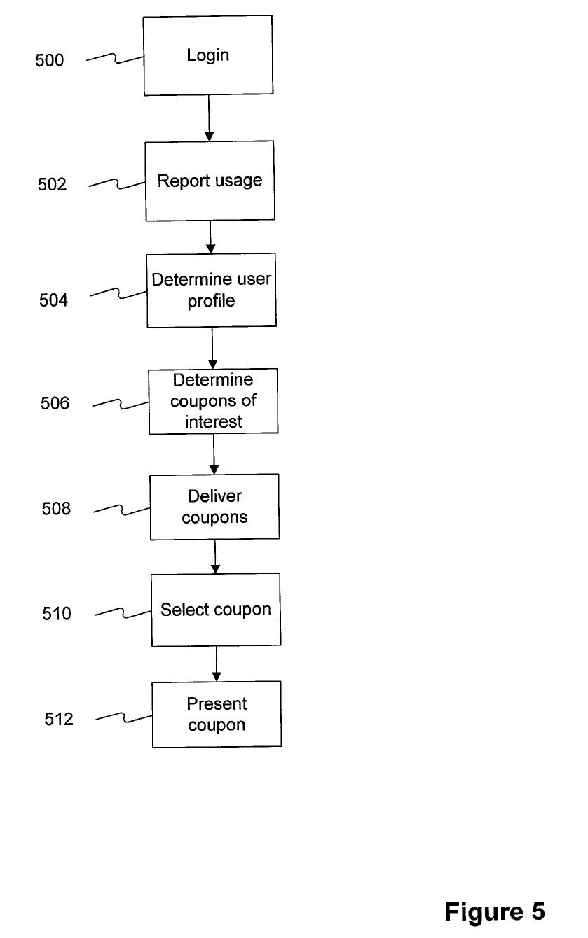

FIG. 5 illustrates a method for redeeming e-coupons consistent with the present invention. A user may use the wireless device 100 to login to the e-coupon server 106 (Step 500). For example, the user may provide a username and password via the wireless device 100. If the user is new, the user may provide initial account information, such as a user's name, address, and proposed password via the wireless device 100.

Upon successful login, the wireless device 100 may report recent e-coupon usage by the user (Step 502). Usage reports may be useful to track the e-coupon usage for marketing data, fraud prevention, user profile refinement, etc. In one embodiment, the wireless device 100 may continuously provide a log of e-coupons used within the past several hours. Alternatively, the wireless device 100 may report e-coupon usage for the previous logged “offline” period since the user disconnected from the public network 104.

The e-coupon server 106 may then retrieve the user's consumer profile from the user profile database 108 (Step 504). The e-coupon server 106 may then select one or more e-coupons from the e-coupon database 110 based on the retrieved profile (Step 506). For example, the e-coupon server 106 may select e-coupons based on web-based content or channels recently viewed by the user, user requests, recent wireless service usage, user history of e-coupon redemption, or any other criteria. In addition, the e-coupon server 106 may include local telephone numbers and locations for redemption based on the user's actual location, as an aid to the user. Alternately, the e-coupon server 106 may include a link to obtain location and telephone numbers from the Web with the e-coupon.

The e-coupon server 106 may then transmit the selected e-coupons to the wireless device 100 (Step 508). For example, the e-coupons may be delivered at regular intervals (i.e., selected by either the user, an entity carrying the e-coupon channel, or the e-coupon server).

Upon receiving the e-coupons from the e-coupon server 106, the user may use the wireless device 100 to select one or more of the e-coupons for redemption (Step 510). For example, the user may search for delivery pizza e-coupons under a “pizza” category or search an unsorted list for “pizza.” Thus, when ordering a pizza, the user may check an e-coupon channel on the wireless device 100 for applicable e-coupons. After selecting an e-coupon for redemption, the user may use the wireless device 100 to present the e-coupon. For example, the wireless device 100 may display the e-coupon number or bar code for redemption. In addition, the wireless device 100 may include logic for displaying only those e-coupon which have not expired as an aid to the user.

The present invention may also be practiced using conventional PDAs, such as those from Palm Computing (TM), which are periodically synchronized via desktop computers having Web access or which are periodically connected to a modem for web access. Thus, the downloading of e-coupons to a device may occur during synchronizing operations or web access, and redemption may occur while “tethered” to a PC or modem or, while away from these devices.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing electronic coupons, comprising:
determining, at a user device, information identifying a user;
requesting, from a processor, an electronic coupon based on the information identifying the user;
determining, at the processor, a profile of the user based on the information identifying the user;
selecting, at the processor, at least one electronic coupon based on the determined profile of the user; and
displaying a redeemable representation of the at least one electronic coupon on the user device.

2. The method of claim 1, further comprising the steps of:
selecting, at the user device, the at least one electronic coupon; and
presenting, at the user device, the selected at least one electronic coupon.

3. The method of claim 2, wherein the step of selecting the at least one electronic coupon comprises determining an expiration for the at least one coupon.

4. The method of claim 3, wherein the step of presenting the selected at least one electronic coupon, comprises the steps of:
presenting the selected at least one electronic coupon, when the expiration has not elapsed for the at least one electronic coupon.

5. The method of claim 1, further comprising the steps of:
determining, at the user device, information describing a history of electronic coupons redeemed by the user;
providing the information describing the history of electronic coupons redeemed by the user to the processor; and
modifying the profile of the user.

6. A system for providing electronic coupons, comprising:
a user device for determining information identifying a user;
a first memory for storing information a profile for the user;
a second memory for storing a plurality of electronic coupons; and
a processor for retrieving the profile of the user and selecting at least one of the plurality of electronic coupons based upon the profile of the user;
wherein the at least one of the plurality of electronic coupons is capable of being redeemed directly from the user device.

7. An apparatus for providing electronic coupons, comprising:
means for determining, at a user device, information identifying a user;
means for requesting, from a processor, an electronic coupon based on the information identifying the user;
means for determining, at the processor, a profile of the user based on the information identifying the user.
means for selecting, at the processor, at least one electronic coupon based on the determined profile of the user; and
means for displaying a redeemable representation of the at least one electronic coupon on the user device.
